(19) United States
(12) Patent Application Publication
(10) Pub. No.: US 2020/0079042 A1
(43) Pub. Date: Mar. 12, 2020

(54) DRUM AND METHOD FOR ASSEMBLING A TIRE ADAPTER ON A RIM

(71) Applicant: COMPAGNIE GENERALE DES ETABLISSEMENTS MICHELIN, Clermont-Ferrand (FR)

(72) Inventors: GERARD BAUMGARTNER, Clermont-Ferrand (FR); THOMAS GUY, Clermont-Ferrand (FR)

(21) Appl. No.: 16/616,005

(22) PCT Filed: May 22, 2018
(86) PCT No.: PCT/FR2018/051220

§ 371 Date: Nov. 22, 2019

(30) Foreign Application Priority Data
May 22, 2017 (FR) 1754509

(51) Int. Cl. B29D 30/24; B29D 30/32

(52) U.S. Cl. CPC B29D 30/247; B29D 30/32; B29D 30/0606; B29D 2030/3264; B29D 30/248

(57) ABSTRACT

A radially expandable building drum (1), intended for the manufacture of an adapter for mounting a tyre on a rim, comprises a central axis (X-X′), and an assembly zone coaxial with the latter and comprising a first set (10) of segments (100) and a second set (20) of segments (200), all the segments being arranged circumferentially around the central axis, in which the segments (100) of the first set (10) and the segments (200) of the second set (20) face one another axially. The external circumferential face of each segment (100, 200) comprises a groove (103, 203) for accommodating a bead wire, and the said drum passes, in the said assembly zone, from a retracted first position of substantially cylindrical shape into an expanded second position of substantially frustoconical shape when the segments (100) are driven by a first cam (300) and the segments (200) by an adjacent second cam (400).

The invention relates to a drum and to a method of assembly for the manufacture of a tyre adapter used for mounting a tyre on a wheel rim.

Document WO 00/78565 discloses such an adapter produced based on reinforced rubber compounds elastically deformable in the axial and radial directions, two adapters connecting the rim to the beads of the tyre making it possible to improve the properties of the latter.

More particularly, such an adapter generally comprises an interior bead which secures the adapter to the rim, an exterior bead intended to accept the bead of the tyre, the interior and exterior beads being connected by a reinforcement that allows the adapter to deform elastically in the radial and axial directions. Such an adapter is created by stacking the various products based on rubber compounds on a support and is then vulcanized in a mould inside a vulcanizing press so that it acquires the desired elasticity properties.

Because of its functions and bearing in mind the requirements associated with mounting, the adapter has a tapering tubular overall shape of very specific profile. Specifically, the shape of the cross section of the adapter is determined by the shape of the cross section of the rim and by the type of associated tyre and its profile is often complex as a result. In addition, the deformation of the adapter during operation needs to occur in a precise direction and to have very precise predetermined values and, as a result, the adapter needs to conform to fairly strict dimensional tolerance conditions. In order to meet these conditions, it is planned for the various components to be assembled by laying them in succession on a rigid core and then vulcanizing in a suitable mould. Although this solution offers good implementational precision, it does nevertheless call for very complex tooling, requiring high levels of investment.

Document WO 2016/096722 in the name of the Applicant Company, describes a method for assembling, on a rigid core, an adapter for mounting a tyre on a rim.

In order to manufacture such an adapter economically and on an industrial scale, bearing in mind its make up and structure which are based on reinforcers and rubber products such as plies or profiled elements similar to those used in the manufacture of a tyre, the use of a building drum has also been envisaged. However, such a drum needs to satisfy several conditions, a first being that is it has sites for accepting beads of different diameters.

Publication EP 0 953 434 describes a building drum for the manufacture of tyres having beads of different diameters. This drum comprises at its ends grooves for receiving beads of different diameters and a retractable ring that covers the smaller-diameter groove in order to form a cylindrical receiving surface on which to lay products that make up the carcass reinforcement. The ring is then removed axially to the outside of the drum in order to turn up the products laid on the drum. While admittedly this makes it possible to create green tyres with beads of different diameters, the presence of such a ring entails precise positioning and adjustment with respect to the drum and moving it with respect to the drum has consequences regarding the space occupied thereby.

One solution to these problems is described in publication EP 1 347 875 which describes an expandable tyre building drum for the manufacture of tyres comprising a cylindrical central surface the ends of which have different diameters and devices for raising the ends of the carcass reinforcement which can be expanded with the drum and are also adjustable to each diameter when the drum is in the expanded position. Although this works satisfactorily for building a tyre, this drum is nevertheless not suitable for building an adapter for mounting a tyre on a wheel rim which, in addition to having a shape which differs from that of a tyre, has beads of different diameters but situated a short distance, generally not exceeding 90 mm 60 mm, apart.

A drum for assembling an adapter for mounting a tyre on a rim which alleviates these problems was proposed in patent application FR15/61358 in the name of the Applicant Company. Satisfactory in its operation, the drum described in that document proves to be fairly complex because of its structure which employs a high number of components.

The object of the invention is a drum for assembling an adapter for mounting a tyre on a rim that makes it possible to at least partially overcome the aforementioned disadvantages.

To this end, the invention proposes a radially expandable building drum intended for the manufacture of an adapter for mounting a tyre on a rim, the said drum comprising a central axis and an assembly zone coaxial with the latter and comprising a first set of segments and a second set of segments, all the segments being arranged circumferentially around the central axis in which the segments of the first set and the segments of the second set face one another axially characterized in that the external circumferential face of each segment comprises a groove for accommodating a bead wire, and in that the said drum is produced in such a way as to pass, in the said assembly zone, from a retracted first position of substantially cylindrical shape into an expanded second position of substantially frustoconical shape when the segments of the first set are driven by a first cam and the segments of the second set by an adjacent second cam.

The drum of the invention makes it possible to build the various components of the green form of adapter for mounting a tyre on a rim, the adapter comprising two bead wires of different diameters, by laying what is referred to as “flat” when the assembly zone (used for the laying of the products) of the drum is in the retracted position (or first working position), in which the segments of each set are at the same diameter, thus generating a cylindrical external surface allowing easy laying of the products. The external circumferential face of each segment has a groove for receiving a bead wire. This allows a bead wire to be positioned and subsequently entrapped within the plies laid on the segments during the building of the green form of the adapter.

The segments of the first set and the segments of the second set face one another axially, and the drum is formed in such a way as to create, in a second working position, a different radial expansion of the segments of one set with respect to the segments of the other set. What is meant by segments that face one another axially or are juxtaposed axially is segments which lie on the same generatrix of the drum, facing one another. In other words, the segments of the first and of the second set are arranged with their longitudinal axis in the one same vertical plane which intersects the axis of rotation of the drum. The segments of the first and of the second set may be situated axially distant from one another or axially close together on the one same generatrix of the drum.

In other words, the drum comprises an assembly or product-laying zone, which is divided in the lengthwise direction of the drum into two parts made up of the two sets of segments axially facing one another. When the drum is in the retracted (or deflated) state, the two parts are at the same diameter, thus forming a drum of cylindrical overall shape. When the drum is in the expanded (or inflated) state, the diameter of the first part is different from that of the second part, thus forming a stepped central zone. In order for the drum to pass from the contracted state into the expanded state, use is made of two adjacent cams each driving the movement of the segments of the drum.

This makes it possible, by using drive means of simplified construction which are also more robust, to achieve asymmetric radial expansion of the drum, as viewed with respect to a vertical midplane which is orthogonal to the main axis about which the drum rotates. On top of that, it is easy to adapt the profile of the cam to suit the radial movement that it is desired to be obtained.

For preference, the cams are able to move axially and comprise ramps each having an inclined profile but having, over at least part of their profile, a different angle from one another. In other words, the cams have ramps that are inclined in the one same direction but at different angles over at least part of their profile coming into contact with the segment supports. In an alternative form, the angles of inclination may be identical in order to have the same radial expansion of the segments of the two sets. For example, with equal inclinations at the start of the ramp on each cam, cylindrical expansion to the one same diameter is achieved for the two sets of segments before the products are laid.

Advantageously, the first cam and the second cam are produced in such a way as to be driven simultaneously by a common actuator. This solution is preferred for its constructional simplicity and in order to obtain synchronous movement of the segments of the two sets using one single actuator advantageously placed along the central axis of the drum.

For preference, the first ramp has an inclined rectilinear profile forming an angle α with an axial direction and the second ramp has an inclined rectilinear profile forming an angle β with an axial direction and in that α<β over at least part of the length of the profile.

Advantageously, each segment is secured to a support provided with a rolling follower which is made to collaborate with the ramp. It would have been possible to envisage bringing the segment supports directly into contact with the ramps of the respective cams. However, a solution of the rolling follower type with the former rolling along the ramp of the cam is preferred in order to facilitate driving and reduce the wearing of the contacting parts and improve the efficiency between the force applied by the shaft and the actual clamping of the components around the bead wires.

For preference, the segments are configured to be guided radially as they move. This makes it possible to have pure radial movement of the segments for greater precision and repeatability of the assembly. This also makes it possible to avoid the generation of unwanted axial movements which would make the clamping of the bead wires in their respective grooves less effective. Such guidance can be achieved by using rolling followers secured to the segment supports which slide on rails of the drum, or else by using ball guides which slide on rails or rods with guide bushings.

For preference, the axially internal face of the segments of the first set comprises teeth which are configured to axially interpenetrate with the teeth of the axially external face of the segments of the second set. This makes it possible to ensure continuity of the external face of the drum in the axial direction between the two cylindrical parts of different diameters of the drum in the expanded position and during the transition of the segments between the retracted and expanded positions.

For preference, the drum comprises two ply-turning devices situated each at one end of the drum. This allows assembly to be finalised by turning the edges of the plies around the bead wires using devices situated in the vicinity thereof.

For preference, the drum comprises means for actuating each ply-turning device independently in an axial translational movement. This allows the device to turn the plies around the bead wires in a manner that is shifted in time. This also allows superposed ply turning to be performed.

The objects of the invention are also achieved using a method of assembly for the manufacture of a tyre adapter used for mounting a tyre on a wheel rim, comprising the following steps:
laying the rubber components on a cylindrical surface, forming an assembly zone, a radially expandable drum with a central axis comprising two sets of segments facing one another axially, by rotating it;
positioning two bead wires coaxially around the central axis of the drum on the rubber components in grooves provided for this purpose in each set of segments;
differently radially expanding the segments of the first set in relation to the segments of the second set of segments between two working positions in order to entrap the rubber components around the bead wires by making the segments collaborate with a first cam and the segments collaborate with an adjacent second cam.

Advantageously, the components are clamped around the smaller-diameter bead wire in a groove provided for that purpose in the first set of segments before the components are clamped around the larger-diameter bead wire. Thus, when the smaller-diameter bead wire is immobilized, the sliding of the products along the tapered inclined face of the drum is better controlled for greater precision and repeatability.

For preference, the method according to one of the claims comprises steps of turning the ends of the rubber components around the bead wires.

The invention will be better understood from the remainder of the description, which is based on the following figures:

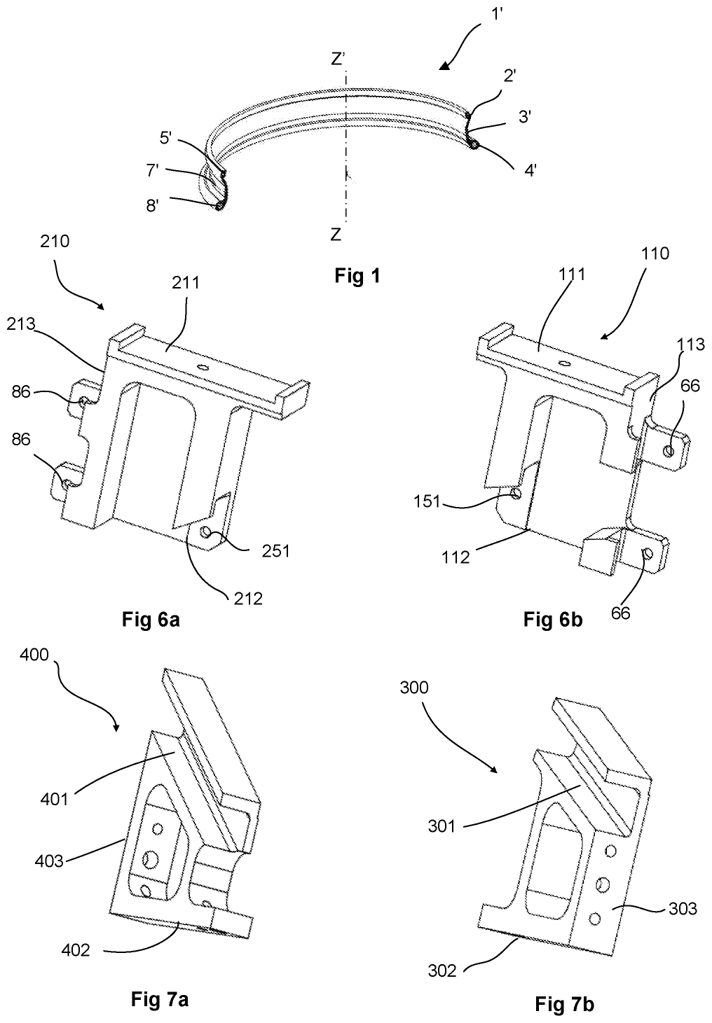

FIG. 1 is a perspective view of an adapter sectioned along a plane passing through its axis of symmetry;

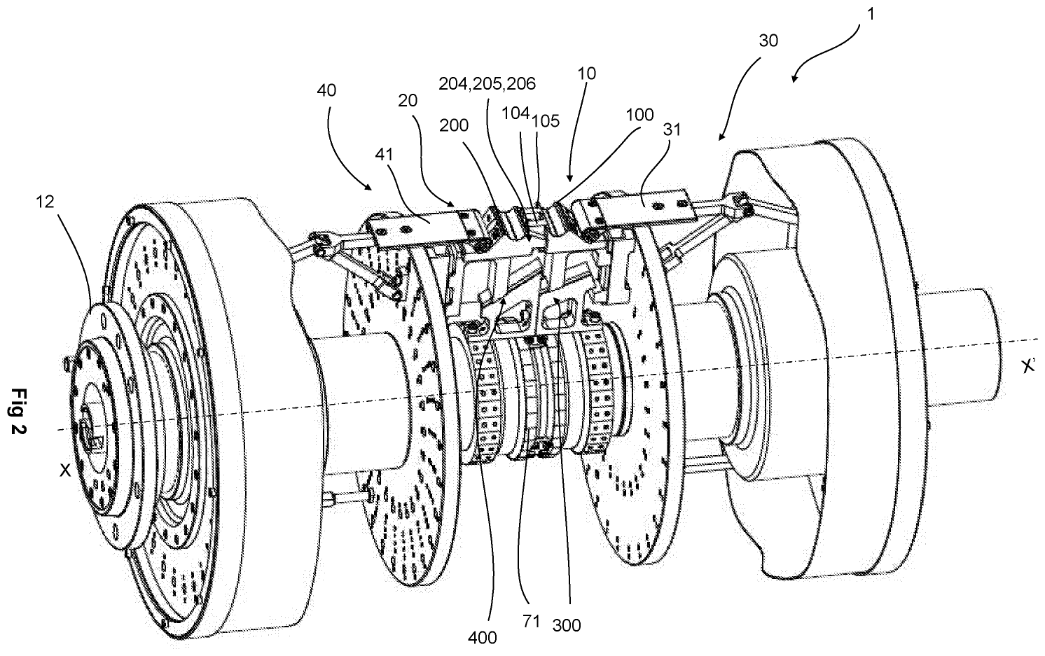

FIG. 2 is a perspective view of a building drum according to the invention shown in retracted position;

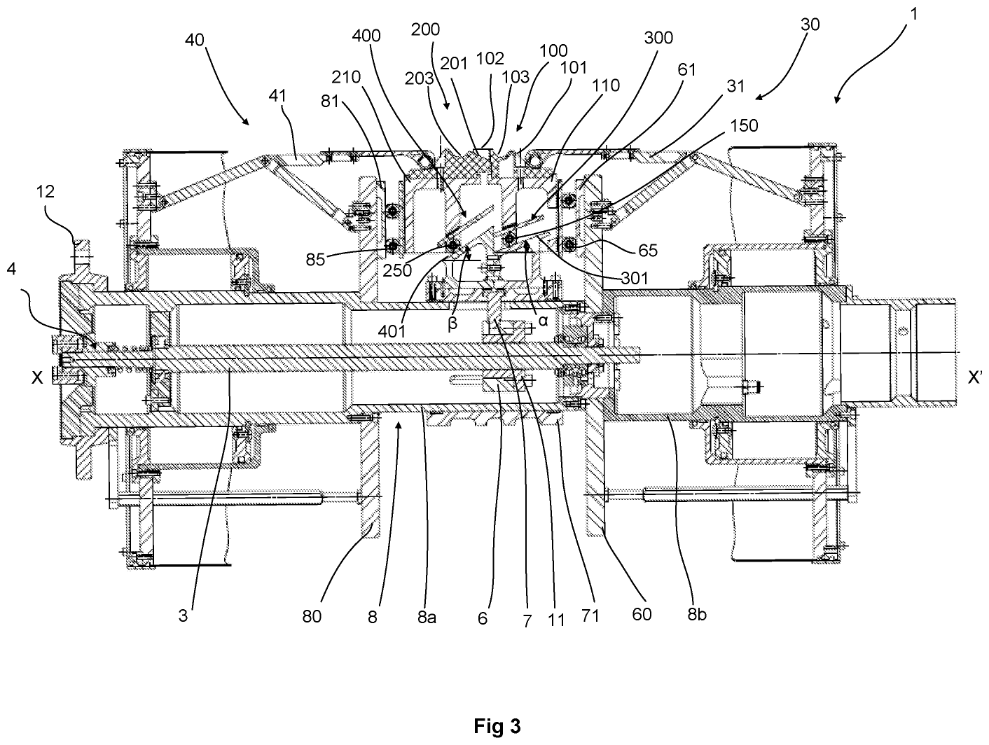

FIG. 3 is a view in axial section of the drum of FIG. 2;

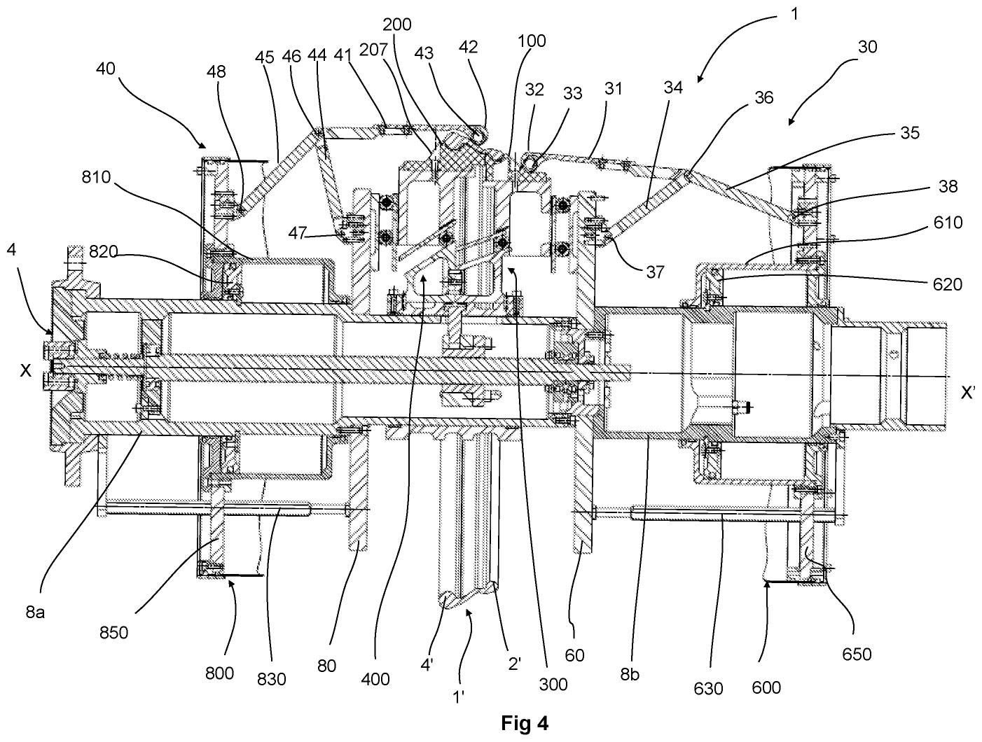

FIG. 4 is a view in axial section of a building drum according to the invention, illustrated in an expanded position during a first ply-turning operation;

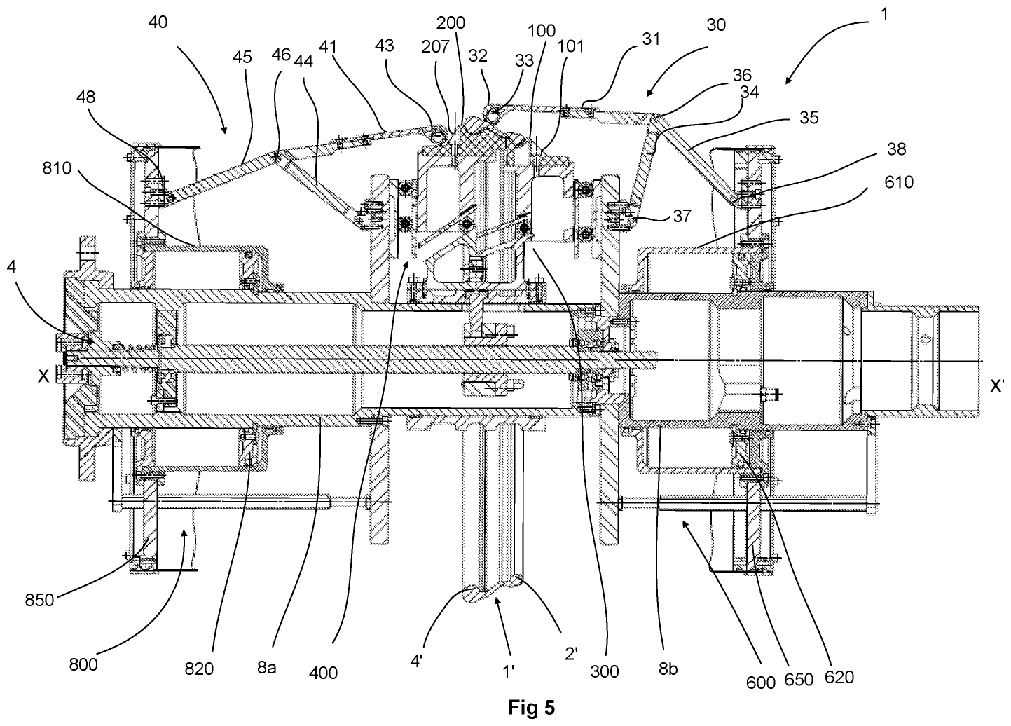

FIG. 5 is a view in axial section of a building drum of the invention illustrated in the expanded position during a second ply-turning operation;

FIGS. 6a to 6b are perspective views of the supports of the segments of the drum of the invention;

FIGS. 7a and 7b are perspective views of one exemplary embodiment of the cams that drive the segments of the drum of the invention.

In the various figures, identical or similar elements bear the same references. Their description is therefore not systematically repeated.

FIG. 1 illustrates an adapter 1′ sectioned along a plane passing through its axis of symmetry Z-Z′. The adapter 1′ is intended to be mounted between a wheel rim and a tyre (neither depicted) to form an assembly of the type described in document WO 00/78565 in the name of the Applicant Company. The adapter 1′ to this end comprises an adapter bead 2′ used for fixing to a wheel rim, an adapter reinforcement 3′ which connects the bead 2′ to an adapter reinforcer 4′ able to be fixed around the bead of a tyre. The adapter 1′ is a component of annular overall shape having symmetry of revolution about the axis Z-Z′.

The reinforcement 3′ of the adapter 1′ is formed on the basis of a main ply of mutually parallel textile cords contained in a rubber base, like a carcass ply. This ply is arranged in such a way as to form a turnup around the reinforcer 4′ of the adapter and, on the other hand, is anchored in the bead 2′ of the adapter 1′ likewise forming a turnup. The adapter bead 2′ comprises a small metal bead wire 5′ around which the said turnup is formed. The reinforcer 4′ comprises a large bead wire 8′ which is a metal tube, or a solid bead wire made from a composite material, or a bundle bead wire (what is meant by a bundle bead wire is a bead wire comprising several superposed layers of circumferential windings of a wire), or alternatively a braided metal bead wire, around which the various rubber-based plies are arranged. The main ply is supplemented by one or more secondary plies, such as a protective ply arranged on the external face 6′ of the adapter, or even a sealing ply or inner liner, arranged on the internal face 7′ of the adapter, or by other filling or filler rubbers in the bead wire area, as will be explained hereinafter. The difference in diameter between the bead 2′ and that of the reinforcer 4′ is approximately 1″.

FIGS. 2 to 5 illustrate, in various operating positions, a building drum 1 according to the invention, intended for the manufacture of an adapter for adapting a rim to a tyre, the vulcanized green form of adapter obtained by assembly then being vulcanized in a mould. For the sake of clarity of the drawings, the drum has been depicted with just one set of segments 100, 200 and their ancillary components situated on the one same generatrix of the drum, as will be explained later.

The drum 1 is mounted on a stand (not depicted) comprising mechanical drive means able to set the drum in rotation about a central axis X-X′, for example by coupling and driving a flange 12 of the drum. In what follows, the axial and radial directions are defined with respect to the central axis X-X′ which is also an axis of symmetry of the drum.

The drum 1 comprises a first set 10 of segments 100 and a second set 20 of segments 200 which face one another axially or, in other words, are axially juxtaposed. The segments 100, 200 of each set are arranged circumferentially on the periphery of the drum to form an external circumferential face 50 of the drum that constitutes the working face or assembly zone on which the elements or components of the green form of the adapter are arranged. The segments 100, 200 have the same width in the circumferential direction, their respective length (measured in the axial direction) being chosen according to dimensions of the adapter that is to be built. The external face 50, when the drum is in the retracted position, has the overall shape of a cylinder of circular cross section in a plane perpendicular to the axis X-X′. Each set of segments is arranged in such a way as to be able to pass from a retracted position to an expanded position and vice versa. When the drum is in the expanded position, as visible in FIGS. 4 and 5, the segments 100 form an external face 51 of cylindrical shape of a diameter smaller than that of the cylindrically-shaped external face 52 of the segments 200.

The drum also comprises ply-turning devices 30, 40 for turning the plies of rubber material arranged on the external face 50. Each ply-turning device is situated at one lateral end of the drum and has its own actuating means, as will be explained hereinafter.

The segments 100 of the first set of segments 10 are all identical to one another. There are 27 of them in the present example, but this number could vary. In this example, each segment is rigid and formed of a single piece having an elongate overall shape, the largest dimension of which is parallel to the axis X-X′. As is better visible in cross section (FIG. 3), a segment 100 comprises a front part 101, of inclined overall shape or in the shape of a portion of a cone extended by a rear part 102 in the overall shape of a portion of a cylinder. The front part 101 has a circular groove 103 intended to accept a bead wire. The groove 103 is coaxial with the axis X-X′ and has a semicircular radial cross section. The rear part 102 is produced in the form of a comb, in this instance, comprising two teeth 104, 105 (FIG. 2). This comb -shaped part makes it possible to ensure continuity in the axial direction of the external face between the segments of the first set 10 and those of the second set 20 so as to facilitate the various operations of pressing-down with a roller, particularly at the welds. Each segment 100 is fixed to a rigid support 110 by means of which it is connected to guide and drive means as will be explained hereinafter.

The segments 200 of the second set of segments 20 are all identical to one another. As with the segments 100, there are 27 of them in the present example, but this number could likewise vary, while remaining equal to the number of segments 100. Each segment 200 is rigid and formed of a single piece having an elongate overall shape, the largest dimension of which is parallel to the axis X-X′. As is better visible in cross section (FIG. 3), a segment 200 comprises a front part 201, of inclined overall shape or in the shape of a portion of a cone extended by a rear part comprising a circular groove 203 coaxial with the axis X-X′ and having a semicircular radial cross section. The front part 201 is produced in the form of a comb comprising, in this example, three teeth 204, 205, 206, which interpenetrate with the teeth 104, 105 of an adjacent segment 100. The segment 200 ends in a conical part 207. Each segment 200 is fixed to a rigid support 210 by means of which it is connected to guide and drive means as will be explained hereinafter.

FIG. 3 is a view in axial section of the drum 1, illustrated in the retracted position, and which best shows the devices of the drum which provide the drive and guidance of the segments 100, 200. The drum 1 comprises a central support or barrel 8 coaxial with the axis X-X′. The barrel 8 is in two parts 8a, 8b which are assembled by screw-fastening. The part 8a is coaxial with a shaft 3 of axis X-X′ which passes through it. The shaft 3 is rotationally driven at one of its ends by an electric motor (not depicted) via a coupling device 4. The shaft 3 comprises a central part forming a screw 5. The screw 5 is intended to drive in axial movement, by means of a nut 11 mounted on the screw, three radial fingers 7 which are uniformly distributed about the axis. The screw-nut mechanism is preferably a ball screw because that provides greater precision and lower friction. Of course, any other type of mechanism that converts a rotational movement about the axis X-X′ into an axial translational movement may be envisioned.

Each radial finger 7 is secured to the nut 11 by means of a clamping piece 6. The radial fingers 7 are rigidly attached to a sleeve 71 mounted with the ability to slide on the barrel 8a. The sleeve 71 is connected to a support 110, 210 for segment 100, 200 by a mechanism that converts the axial movement of the sleeve into a radial movement of the segments 100, 200. Each segment 100, 200 is rigidly fixed to its segment support 110, 210 in such a way that the position of the latter fully determines the position of the segment.

According to the invention, the drum 1 is produced in such a way as to pass from a retracted first position into an expanded second position when the segments 100 are collaborating with the ramp 301 of a first cam 300, and the segments 200 are collaborating with the ramp 401 of a second cam 400, the cams being able to move axially in connection with the sleeve 71 and their ramps 301, 401 having an inclined profile, the angle of inclination of the ramp 301 being different from the angle of inclination of the ramp 401 over at least part of their profile. More specifically, the supports 110 and 210 of the segments of the drum comprise, at an upper end 111, 211, respectively, means of attaching a segment 100, 200 and are provided, at a lower end 112, 212, respectively, with following rollers 150, 250, respectively, which come into contact with the ramps 301, 401, respectively, of the cams 300, 400. As is better visible in FIG. 3, the ramp 301 makes an angle α with a horizontal direction parallel to the axis X-X′ and the ramp 401 makes an angle β with a horizontal direction parallel to the axis X-X′, where α is less than β. The cams 300, 400 are fixed to one another and also fixed to the sleeve 71 by fixing screws. By way of example, for an adapter the largest diameter of which is 500 mm and the length of which is approximately 60 mm, α=20° and β=34°.

During operation, when the shaft 3, and therefore the screw 5, is turned, the radial fingers 7, and therefore the sleeve 71 bearing the cams 300, 400, are made to move axially. The axial movement of the cams at the same speed causes the segments 100, 200 to move radially to different radial heights from one another in order, at the end of the travel, to achieve the positioning of the segment 200 at a greater diameter to that of the segment 100, as is best visible in FIGS. 4 and 5. The effect of this is that the radial movement of the segments 200 of the second set 20 is greater than that of the segments 100 of the first set 10. The front part 201 of the segments 200 has a tapering shape and is produced in the form of a comb and, as a result, ensures continuity in the axial direction of the external face of the drum when the drum is in the expanded position. Thus, when there is different radial expansion between the two sets of segments, the external face which, when the drum was in the retracted position, was cylindrical and allowed the various components to be laid “flat” (as visible in FIG. 3) becomes tapered when the drum is in the expanded position (as visible in FIGS. 4 and 5), thereby making it possible to perform the finishing of the assembly, as will be explained later on.

To ensure perfect radial movement of the segments, the latter are guided radially, via their supports, when driven by the cams 300, 400 and the respective following rollers. Guide rails 61, 81 providing guidance in the radial direction are provided for this purpose on the radially external part of the internal lateral face (the one facing the segments) of the two inflation plates 60 and 80. Each segment support 110, 210 is provided with following rollers 65, 85 which run along the guide rails 61, 81.

The supports 110, 210 are best visible in FIGS. 6a and 6b, and the cams 300, 400 in FIGS. 7a and 7b. The support 110 comprises a bore 151 in which the shaft that supports a following roller 150 is mounted. The following roller 150 is mounted with the freedom to rotate and follows the ramp 301 of the cam 300. Two bores 66 are provided on the external lateral face 113 of the support 110 and support the shafts of the following rollers 65. Similarly, the support 210 comprises a bore 251 in which the support shaft of a following roller 250 is mounted. The following roller 250 is mounted with the freedom to rotate and follows the ramp 401 of the cam 400. Two bores 86 are provided on the external lateral face 213 of the support 210 and support the shafts of the following rollers 85. The cams are fixed together at their lateral faces 303 and 403 and to the sleeve 71 via their base 302, 402, using screw fastenings. The ramps 301 and 401 are produced in the form of slots in which the following rollers 65 and 85 run, ensuring positive driving of the supports 110, 210 as the drum 1 expands and contracts.

The profile of the ramps 301 and 401 determines the position of the segments 100, 200 at any given moment. Thus, in one alternative form of embodiment, the profile of the ramps 301 and 401 is different along their entire length. In another alternative form, the profile of the ramps 301 and 401 is identical over part of their length and differs over the remainder of their length. What is meant by profile that is identical is a profile in the form of an inclined ramp of a given angle that is identical for both ramps.

The drum also comprises, for each segment 100, 200, two ply-turning devices 30, 40 comprising ply-turning arms that come into contact with the rubbery plies of the green form. The drum moreover comprises means for driving the ply-turning arms, as will be explained later.

The first ply-turning device 30 is situated in the right-hand part of the drum, it comprises, for each pair of adjacent segments 100, 200, a ply-turning arm 31 arranged, in the retracted position, parallel to the axis X-X′ and which is directly connected, at its left-hand end, to a hook 32 which is attached to a circumferential ply-turning spring 33 mounted slightly under tension on the drum 1, the latter being in the retracted position. The arm 31 is mounted with the ability to pivot about an articulation 36 to which two link rods 34 and 35 are also pivotably connected. The link rod 34 is mounted on the inflation plate 60 via an articulation 37. The link rod 35 is mounted on a ram plate 650 via an articulation 38. The axes of the articulations 36, 37 and 38 are mutually parallel and are perpendicular to the axis X-X′ of the drum. The inflation plate 60 and ram plate 650 are in the overall shape of a disc; they extend in a plane perpendicular to the axis X-X′ and are centred thereon.

The drum comprises a first annular ram 600, for example a pneumatic ram which acts as a means for actuating the axial translation of the ply-turning device 30. The ram 600 comprises a ram body 610 which is arranged in a fluidtight manner and with the possibility of sliding axially along the barrel 8b of the drum 1. The annular ram 600 comprises an annular piston 620 mounted fixedly on the barrel 8b and a rotation-blocking rod 630. When the internal chamber of the ram 600 is supplied with pressurized gas, the casing of the ram 610 moves in axial translation; it drives the movement of the rod 35 and brings about the forward movement of the arm 31.

When it receives the axial translational thrusting movement of the ram 600, the arm 31 moves to the left in FIG. 5 and pushes the spring 33 along the gradient of the front part 101 of a segment 100 in order to turn the plies around the bead wire placed in the groove 103. At the end of the ply-turning, the ram 600 is commanded in the opposite direction and the arm 31 retracts into its initial or rest position. In this particular instance, there are 27 of the ply-turning devices 30 and the arms 31 are actuated simultaneously by the ram 600.

The second ply-turning device 40 is similar to the first one. It comprises, for each pair of adjacent segments 100, 200, a ply-turning arm 41 arranged, in the retracted position, parallel to the axis X-X′ and which is directly connected, at its right-hand end, to a hook 42 which is attached to a circumferential ply-turning spring 43 mounted slightly under tension on the drum 1, the latter being in the retracted position. The arm 31 is mounted with the ability to pivot about an articulation 46 to which two link-rods 44 and 45 are also pivotably connected. The link rod 44 is mounted on the inflation plate 80 via an articulation 47. The link rod 45 is mounted on a ram plate 450 via an articulation 48. The axes of the articulations 46, 47 and 48 are mutually parallel and perpendicular to the axis X-X′ of the drum. The inflation plate 80 and the ram plate 850 have the overall shape of a disc; they extend in a plane perpendicular to the axis X-X′ and are centred thereon.

The drum comprises a second annular ram 800, for example a pneumatic ram which serves as a means for actuating the axial translation of the ply-turning device 40. The ram 800 comprises a ram body 810 which is arranged in a fluidtight manner and with the possibility of sliding axially along the barrel 8a of the drum 1. The annular ram 800 comprises an annular piston 820 mounted fixedly on the barrel 8a and a rotation-blocking rod 830. When the internal chamber of the ram 800 is supplied with pressurized gas, the casing of the ram 810 moves in axial translation, drives the movement of the rod 45 and brings about the movement whereby the arm 41 is raised.

When it receives the axial translational thrusting movement of the ram 600, the arm 41 moves to the right in FIG. 4 and pushes the spring 43 on the gradient of the rear part 207 of a segment 200 in order to turn the plies around the bead wire placed in the groove 203. At the end of the ply-turning, the ram 800 is commanded in the opposite direction and the arm 41 retracts into its initial or rest position. In this particular instance, there are 27 of the ply-turning devices 40, and the arms 41 are actuated simultaneously by the ram 800.

The segments 100 and 200 are situated one in the continuation of the other with a distance of approximately 55 mm between the grooves 103 and 203. In one alternative form of embodiment of the invention, the drum is preferably covered on its entire length with an elastic sleeve which covers the spaces that there are in the axial and circumferential directions between the segments when the drum is in the expanded position, in order to prevent marks from being formed on the raw rubber.

The components of the drum are made predominantly of metal, for example some of aluminium and others of steel. In one alternative form, the upper parts, or parts for contact with the rubber plies, of the segments 100 and 200 may be produced by a 3-D printing technique (based on a resin or a metallic powder), for greater flexibility in producing these.

This drum is used for producing an unvulcanized green form of adapter for a tyre. A method for assembling an adapter using the drum will now be described.

The laying of the product begins with the drum being brought back into the retracted position, as illustrated in FIGS. 2 and 3, or the position in which the external face 50 of the drum is cylindrical. The segments 100 and 200 have their external faces at the same level, and this allows the products to be laid “flat”. Thus, to begin with, the various rubber-based plies are laid (what is meant by various plies is at least one protective ply and one carcass ply equipped with reinforcing threads), followed by the bead apex, these being assembled while the drum 1 is rotating about the axis X-X′. Next, the small bead wire 5′ and the large bead wire 8′ are positioned facing the grooves 103, 203.

Once all the components have been laid on the drum, the latter is commanded to expand in order to arrive at the expanded configuration illustrated in FIG. 4. In order to arrive at this configuration, the central shaft 3 is rotated and this results, through the axial movement of the sleeve 71 and the collaboration of the rolling followers 65 with the ramps 301 and of the rolling followers 85 with the ramps 401, in radial expansion of all the segments simultaneously, but asymmetrically with respect to a vertical midplane passing through the junction between the two sets of segments. As the drum expands, because of the greater thickness of the plies in the vicinity of the small bead wire 5′, this one is the first to be immobilised in the groove 103 of the segments 100, making it possible to control the slippage of the plies on the tapering part of the expanded drum. At the end of expansion, the two bead wires 5′ and 8′ are entrapped, with the rubber components in the grooves 103, 203 of the segments 100, 200 of the drum, the ply-turning devices 30, 40 still being retracted under the components.

FIG. 4 illustrates the ply-turning of the left-hand side of the green form using the second ply-turning device 40. The hook 42 of the device is actuated in an axial translational movement by the ram 800. The hook moves the spring 43 to the right and moves up the sloping part 207 of the segments 200, making it possible to lift the edges of the components above the bead wire 8′.

The spring 43, which is mounted slightly under tension when the drum is in the retracted position, thus allows the necessary pressure to be applied to the turned-over edges of the components in order to cause them to adhere to those of the central part of the green form of the adapter and expel the air. At the end of the ply-turning, the device 40 performs a retracting movement, actuated by the ram 800 until it adopts the position illustrated in FIG. 5.

FIG. 5 illustrates the ply-turning of the right-hand side of the green form using the first ply-turning device 30. The hook 32 of the device is actuated in an axial translational movement by the ram 600. The hook moves the spring 33 towards the left, making it possible to lift the edges of the components above the bead wire 5′. When the rod 31 is pushed, the hook 32 pivots about the articulation 36, allowing it to rise up the slope 101 of the segment 100 pushing the edges of the rubber plies which thus pass over the bead wire 5′. The hook 32 drives the motion of the spring 33 which applies the necessary pressure to the turned-over edges of the components in order to cause them to adhere to those of the central part of the green form of the adapter and expel the air.

At the end of the ply-turning, the ram 600 commands the retracting movement of the device 30 into the retracted position (as visible in FIG. 4).

After the two ply-turning devices have been returned to a retracted position underneath the segments, the central shaft 3 is actuated in the opposite direction and the drum is returned to the retracted configuration so that the green form 1′ can be extracted. The unvulcanized green form thus obtained is then vulcanized in a mould.

Of course, numerous modifications may be made to the invention without departing from the scope thereof.

In one alternative form, the cams have no slots and comprise external ramps on which the following rollers of the segment supports roll. In that case, the drum comprises a flexible sleeve designed to cover its external face and ensure the return movement of the segments to the retracted position.

The cams may be driven in axial motion using a pneumatic or hydraulic ram.

1-12. (canceled)

13. A radially expandable building drum intended for the manufacture of an adapter for mounting a tire on a rim, the drum comprising a central axis and an assembly zone coaxial with the central axis and comprising a first set of segments and a second set of segments, all the segments being arranged circumferentially around the central axis, and the segments of the first set and the segments of the second set facing one another axially,
wherein an external circumferential face of each segment comprises a groove for accommodating a bead wire, and
wherein the drum is produced in such a manner as to pass, in the assembly zone, from a retracted first position of substantially cylindrical shape into an expanded second position of substantially frustoconical shape when the segments of the first set are driven by a first cam and the segments of the second set by an adjacent second cam.

14. The drum according to claim 13, wherein the first cam and the second cam are able to move axially, the first cam comprising a first ramp, the second cam comprising a second ramp, and each ramp having an inclined profile and having, over at least part of the profile, an angle different from one another.

15. The drum according to claim 13, wherein the first cam and the second cam are produced in such a manner as to be driven simultaneously by a common actuator.

16. The drum according to claim 14, wherein each first ramp has an inclined rectilinear profile forming an angle α with an axial direction, each second ramp has an inclined rectilinear profile forming an angle β with an axial direction, and α<β over at least part of the length of the profile.

17. The drum according to claim 14, wherein each segment is secured to a support provided with a rolling follower which is made to collaborate with a ramp.

18. The drum according to claim 13, wherein the segments are configured to be guided radially as they move.

19. The drum according to claim 13, wherein an axially internal face of each segment of the first set comprises teeth which are configured to axially interpenetrate with teeth of an axially external face of the segments of the second set.

20. The drum according to claim 13 further comprising two ply-turning devices, one situated at each end of the drum.

21. The drum according to claim 20 further comprising means of actuating each ply-turning device independently in an axially translational movement.

22. A method of assembly for the manufacture of a tire adapter used for mounting a tire on a wheel rim, comprising the following steps:
laying rubber components on a cylindrical surface, forming an assembly zone, of a radially expandable drum with a central axis and comprising two sets of segments facing one another axially, by rotating it;
positioning two bead wires coaxially around the central axis on the rubber components in grooves provided for this purpose in each set of the segments;
differently radially expanding the segments of the first set in relation to the segments of the second set between two working positions in order to entrap the rubber components around the bead wires by making the segments of the first set collaborate with a first cam and the segments of the second set collaborate with an adjacent second cam.

23. The method according to claim 22, wherein the rubber components are clamped around a smaller-diameter bead wire in a groove provided for that purpose in the first set of segments before the components are clamped around a larger-diameter bead wire.

24. The method according to claim 22 further comprising the step of turning the ends of the rubber components around the bead wires.
